(19) United States
(12) Patent Application Publication
(10) Pub. No.: US 2004/0011398 A1
(43) Pub. Date: Jan. 22, 2004

(54) Dosing valve

(76) Inventors: David Gareth Harvard Davies, Glenrothes (GB); Edward Lessels Norman, Glenrothes (GB)

Correspondence Address: Gregory J. Lavorgna, Drinker Biddle & Reath, One Logan Square, 18th & Cherry Streets, Philadelphia, PA, 19103-6996, US

(21) Appl. No.: 10/344,392

(22) PCT Filed: Jul. 4, 2001
(86) PCT No.: PCT/GB01/03000

(30) Foreign Application Priority Data
Aug. 10, 2000 (GB) 00195529

(51) Int. Cl. G05D 11/00

(52) U.S. Cl. 137/114

(57) ABSTRACT

A dosing valve apparatus for introducing a metered dose of a second fluid to a first fluid comprises a first, or main body, portion (1), a second ball valve portion (3) and an end cap (2). The main body (1) and ball valve (3) contain first and second chambers (13, 14), respectively, into which flow the first and second fluids. An orifice jet (8) and needle valve (11) control flow of the second fluid from the second chamber (14) to the first chamber (13). Within the first chamber (13) is a pivotable paddle (7) which is adapted to act upon the needle valve (11). In this way, flow of the first fluid into the first chamber (13) acts upon the paddle (7), which in turn causes the needle valve to at least partially open the orifice (8) allowing the second fluid into the first chamber (13) to mix with the first fluid.

The present invention is directed to a valve assembly and, more particularly, to a dosing valve assembly for introducing metered amounts of a second fluid to a first fluid.

In many technical processes, there is the need to mix first and second fluids together at very specific ratios. If the fluids are not mixed at the correct ratio, then this can provide problems further along the process path should the incorrect amount of second fluid be added to the first fluid. In addition, it can be uneconomic should the second fluid be added to the first fluid in greater quantities than necessary. An example of such a process would be where fuel additive is to be introduced to fuel in an internal combustion engine. This may be an additive to unleaded fuel for use in petrol engines designed to run on leaded fuel. It may also be any other additive added to any liquid fuel in order to enhance, improve, protect or clean components or associated components of an internal combustion engine, located between fuel input to exhaust output.

Using the example of adding additive to unleaded fuel, at present such additives are purchased in bottles or containers having a measuring cap and the purchaser is then required to add a specific amount of additive into the fuel tank of the vehicle when filling up with fuel. This is an unsatisfactory arrangement, as whether the correct amount of additive is added to the fuel is entirely down to the purchaser. In order to ensure that the correct amount of additive is added, it is preferable to have an automatic arrangement, whereby the step of manually adding the additive in prescribed doses is removed.

It is therefore the aim of the present invention to provide an automatic dosing apparatus that ensures that the correct amount of a second fluid is added to a first fluid.

According to the present invention there is provided a dosing valve apparatus for adding a second fluid to a first fluid, said apparatus comprising:

a valve body defining first and second chambers for receiving said first and second fluids respectively, said first chamber having a first inlet and a first outlet and said second chamber having a second inlet and a second outlet;

an orifice providing fluid communication between said second outlet and said first chamber; and

first valve means controlling flow of said second fluid through said orifice into said first chamber,

wherein said valve means comprises a needle valve slidingly located at least partially within said orifice, and a paddle member pivotally supported in said first chamber, the paddle member being adapted so as to act on the needle valve under the action of the first fluid flow.

Preferably, said paddle member comprises two orthogonal plates.

Preferably, said apparatus further comprises a second valve means located in said second chamber to selectively close or open said second outlet.

Preferably, said second valve means comprises a ball valve and a ball valve seat adjacent said second outlet.

Preferably, said paddle member is pivotable between first and second positions, said first and second positions corresponding to closed and open positions of said needle valve, respectively. Preferably, said paddle member is movable between one or more intermediate positions between the first and second positions, corresponding to one or more partially open states of the needle valve. Preferably, said apparatus further comprises biasing means to bias said paddle member in the first position. Most preferably, said biasing means is a torsion spring.

Preferably, said apparatus further comprises a filter means located in said second chamber adjacent said second inlet.

Preferably, said valve body comprises first and second portions, said second portion being threadedly received on said first portion. Preferably said first and second chambers are located in said first and second portions, respectively. Preferably, said valve body further comprises an end cap adapted to be threaded to said first portion so as to define an end of said first chamber.

Preferably, said orifice is threadedly received in said valve body. Preferably, said orifice can be interchanged with a plurality of orifices each having different diameters.

Preferably, said first fluid is a fuel and said second fluid is a fuel additive.

A preferred embodiment of the present invention will now be described, by way of example only, with reference to the accompanying drawings, in which:

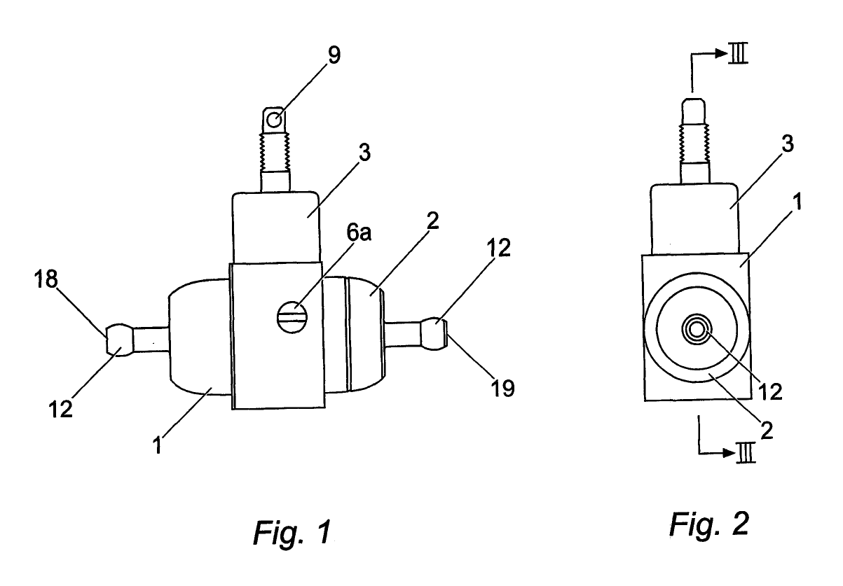

FIG. 1 is a side elevation of a dosing valve in accordance with the present invention;

FIG. 2 is an end elevation of the dosing valve shown in FIG. 1;

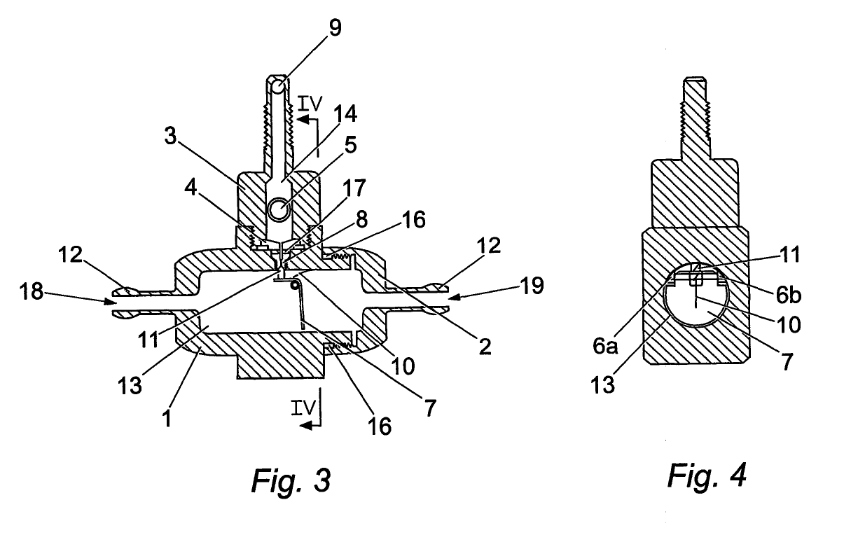

FIG. 3 is a cross section of the dosing valve of FIGS. 1 and 2 along line III-III; and

FIG. 4 is a cross section of the dosing valve of FIGS. 1, 2 and 3 along line IV-IV.

In the embodiment shown, the valve is to be used for adding measured doses of a fuel additive to a fuel in the fuel delivery system of an internal combustion engine. However, it is to be understood by the skilled person that the invention is not restricted to this particular application. FIGS. 1 and 2 show side and end elevations, respectively, of a preferred embodiment of a dosing valve in accordance with the present invention. The valve body is comprised of a first, or main, body portion 1, a second ball valve portion 3 and an end cap 2. Both the ball valve portion 3 and end cap 2 are threaded on to the main body portion 1 to form the complete valve body. The main body 1 has an inlet 18 defined by a hose connector 12 which receives a hose (not shown) thereon. The main fluid, in this case fuel, is delivered to the inlet 18 by the hose. The end cap 2 also has a hose connector 12, which in this instance defines an outlet 19. A second hose (not shown) is fitted to the outlet 19 to allow the mixed fluids to leave the valve assembly. As will be explained later with respect to FIG. 3, the end cap 2 when fitted defines a first, or main, chamber 13.

The ball valve 3 is threaded directly onto the main body 1. The purpose of the ball valve 3 is to allow a second fluid—in this example, a fuel additive—to be added to the main fluid in the first chamber 13 in metered doses, while ensuring that no air enters the main chamber should the second fluid run out.

The internal components of the valve assembly will now be described with reference to FIGS. 3 and 4. As stated above, the main body 1 partially defines a first chamber 13 into which a first fluid flows via inlet 18. With the addition of end cap 2, the first chamber 13 is defined completely. An O-ring 16 is provided between the main body 1 and end cap 2 so as to prevent air ingress or fluid egress from the valve. A second chamber 14 is provided in the ball valve 2, from where the second fluid is passed into the first chamber 13. As can be seen best in FIG. 3, the ball valve 2 comprises a ball 5 in the second chamber 14 and a ball seat 4 adjacent the outlet of the second chamber 14. The ball valve 2 is provided to ensure that no air is allowed to enter the first chamber 13 should the second fluid run out. Thus, as the second fluid level drops during dosing, the ball 5 will also drop, and when the level of the second fluid reaches zero, the ball 3 will rest in the ball seat 4, thereby blocking the path of any air from the second chamber 14 into the first chamber 13. The ball 3 will rise with the second fluid level when more fluid enters the second chamber 14, thereby opening the path for the second fluid into the first chamber 13. In the application of this example, it is extremely undesirable to have air mix with the fuel in the first chamber 13 as this will lead to performance problems for the engine.

At the inlet to the second chamber 14, a filter 9 is provided to ensure fine micron protection. As will be described below, an interchangeable orifice jet 8 and a needle valve 11 are provided to meter the second fluid flow into the first chamber 13. The filter ensures that no debris enters the orifice 8 to affect the precisely calculated second fluid flow. The filter 9 in this particular embodiment is cylindrical and lies transverse to the flow of second fluid into the second chamber 14.

The main body 1 of the valve has a threaded aperture for receiving the aforementioned orifice jet 8. With the ball valve 3 removed, the orifice jet 8 can be interchanged with other jets depending on the rate of second fluid flow required. A range of orifices can be provided which each have a predetermined rate of flow. Thus, different size orifices may be inserted depending on the operational requirements of the valve.

Once the required orifice jet 8 has been inserted, a compression washer 17 is fitted on top of the orifice jet 8 prior to the ball valve 3 being fitted. Again, as with the O-ring 16, the compression washer 17 prevents egress or ingress at the join of the main body 1 and ball valve 3.

The control of second fluid flow through the orifice jet 8 is effected by a pivotable paddle member 7 in the first chamber which is connected to the needle valve 11 by a Circlip™ (not shown) or similar connecting means. The paddle member 7 is formed as a plate which is bent so as to provide two flat surfaces substantially at right angles to each other. The paddle 7 is pivotable about a spindle assembly consisting of male 6a and female 6b spindle components. The male component 6a is threaded into the first chamber 13 through the side wall of the main body 1 so that the paddle 7 is suspended from the male component 6a, as seen in FIGS. 1 and 4. The female component 6b is threaded into the first chamber 13 from the opposite side of the main body 1 and receives the end of the male component 6a therein. O-rings (not shown) are provided on each component 6a,6b to seal the component apertures in the walls of the valve body 1. The paddle member 7 is adapted so that it can pivot about the spindle arrangement, and a torsion spring 10 is provided to bias the paddle in a position whereby the orifice jet 8 is closed.

The way in which the valve operates will now be described, with particular reference to FIGS. 3 and 4. In this example, fuel flows into the first chamber 13 through inlet 18. This incoming fuel flow acts upon the pivoting paddle member 7, forcing the paddle 7 to pivot upwards against the action of the torsion spring 10. With the movement of the paddle 7, the needle valve 11 to which the paddle 7 is connected will be partially removed from the orifice 8, thereby allowing fuel additive to flow from the second chamber 14 into the first chamber 13 to mix with the fuel. While the needle valve 11 remains open, fuel additive will continue to flow at a predetermined rate through the orifice jet 8 until such time as the additive is finished. Then, the ball 5 of the ball valve 3 will locate in its seat 4 and prevent air being drawn through the orifice 8 into the first chamber 13 to mix with the fuel. Once fuel flow through the first chamber 13 stops, the paddle member 7 will pivot back into its rest position under its own weight, as it is counterbalanced. As a result, the needle valve 11 will be forced back into the orifice 8, thereby stopping flow of the additive into the first chamber. The torsion spring 10 ensures that a strong seal between the needle valve 11 and orifice 8 is achieved when the paddle 7 is in the rest position.

Thus, the valve provides a dosing arrangement which operates solely on flow and demand. If no fuel is required by the engine, then no fuel will flow through the first chamber and therefore no additive will be permitted to flow into the first chamber. Only when fuel is required and flows into the first chamber will the paddle and needle valve arrangement allow the additive into the first chamber to mix with the fuel. Thanks to the arrangement of the valve assembly of the present invention, no external actuation means is required to operate the valve, as the valve is entirely mechanical in its operation and operates solely on the flow of the fuel.

The various valve components are manufactured from either aircraft grade aluminium or brass with appropriate machine finishes (N5 or better). Each of the aluminium parts (e.g. main body, end cap and ball valve) are anodised before assembly to provide a very smooth finish. However, other suitable metals or materials may also be used, depending on the application requirements of the valve. The aforementioned seals and O-rings are preferably made from Viton 70™, which has a high resistance to aggressive chemicals.

The ball valve seat has a preferred angle of 15° to the horizontal, however the angle may be adapted depending on the size of the ball being used. The ball itself is of hollow construction and made from high-density polyethylene because, as with Viton 70™, this material is resistant to aggressive chemicals. Again, however, different materials may be used for different applications.

In applications where external vibration of the assembly may occur (eg. internal combustion engine), the torsion spring ensures that no operation of the paddle due to vibration occurs when no fuel is required. Furthermore, the spring provides damping to the paddle motion. The preferred torque of the spring is 0.00432 Nmm per degree of deflection, however this may be adjusted depending on application. The preferred material for the torsion spring is stainless steel wire, although other suitable materials may also be used.

The size of the orifice jet and height of the needle valve may both be determined by calculation during manufacture so as to ensure correct dosing of the second fluid. Thus, the assembly can be provided with additional orifices and needle valves for use in different applications. In addition, depending on the application, a frit insert may be placed in the upper, pre-jet portion of the orifice to act as a high porosity flow restrictor. The insert can be added where very low dilution rates of the second fluid are required.

As previously noted, the second chamber filter of the preferred embodiment is located transverse to the flow of second fluid into the second chamber. In the preferred embodiment, a thread is provided on the outer surface of the neck of the ball valve so that a reservoir for the second fluid may be attached. However, the filter may also be positioned in the neck of the ball valve in parallel with the second fluid flow into the second chamber. In this way the filter may be removed from the ball valve and either cleaned or replaced entirely. With this alternative embodiment, a hose connector would be provided on the neck of the ball valve in place of the thread, so that the second fluid may be delivered to the ball valve from a remote reservoir.

These and other modifications and improvements can be incorporated without departing from the scope of the invention.

1. A dosing valve apparatus for adding a second fluid to a first fluid, said apparatus comprising:
a valve body defining first and second chambers for receiving said first and second fluids respectively, said first chamber having a first inlet and a first outlet and said second chamber having a second inlet and a second outlet;
an orifice providing fluid communication between said second outlet and said first chamber; and
first valve means controlling flow of said second fluid through said orifice into said first chamber,
wherein said valve means comprises a needle valve slidingly located at least partially within said orifice, and a paddle member pivotally supported in said first chamber, the paddle member being adapted so as to act on the needle valve under the action of the first fluid flow.

2. The apparatus of claim 1, wherein the paddle member comprises two orthogonal plates.

3. The apparatus of either claim 1 or claim 2, further comprising a second valve means located in said second chamber to selectively close or open said second outlet.

4. The apparatus of claim 3, wherein the second valve means comprises a ball valve and a ball valve seat adjacent said second outlet.

5. The apparatus of any preceding claim, wherein the paddle member is pivotable between first and second positions, said first and second positions corresponding to closed and open positions of said needle valve, respectively.

6. The apparatus of claim 5, wherein the paddle member is movable between one or more intermediate positions between the first and second positions, corresponding to one or more partially open states of the needle valve.

7. The apparatus of any preceding claim, further comprising biasing means to bias said paddle member in the first position.

8. The apparatus of claim 7, wherein the biasing means is a torsion spring.

9. The apparatus of any preceding claim, further comprising a filter means located in said second chamber adjacent said second inlet.

10. The apparatus of any preceding claim, wherein the valve body comprises first and second portions, said second portion being threadedly received on said first portion.

11. The apparatus of claim 10, wherein the first and second chambers are located in said first and second portions, respectively.

12. The apparatus of either claim 10 or claim 11, wherein the valve body further comprises an end cap adapted to be threaded to said first portion so as to define an end of said first chamber.

13. The apparatus of any preceding claim, wherein the orifice can be interchanged with a plurality of orifices each having different diameters.

14. The apparatus of claim 13, wherein the orifice is threadedly received in said valve body.

15. The apparatus of any preceding claim, wherein the first fluid is a fuel and the second fluid is a fuel additive.
